(19) United States
(12) Patent Application Publication
(10) Pub. No.: US 2010/0107931 A1
(43) Pub. Date: May 6, 2010

(54) MINERAL ORE EXPANSION USING MICROWAVE ENERGY

(75) Inventor: John S. Roulston, Lompoc, CA (US)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: World Minerals, Inc., Santa Barbara, CA (US)

(21) Appl. No.: 12/531,937

(22) PCT Filed: Mar. 20, 2008
(86) PCT No.: PCT/US08/57762

§ 371 Date: Dec. 8, 2009

Related U.S. Application Data
(60) Provisional application No. 60/896,370, filed on Mar. 22, 2007.

(51) Int. Cl. C08K 7/26; B01J 19/12

(52) U.S. Cl. 106/409; 422/186

(57) ABSTRACT

Methods and systems for expanding mineral ore, including perlite, are disclosed. Microwave energy is generated and applied to at least one gas. The energized gas then contacts particles of at least one mineral ore, wherein the transfer of energy softens the particles and boils the water contained therein, thereby at least partially expanding the particles.

### CLAIM OF PRIORITY

This International PCT application claims the right and benefit of priority to U.S. Provisional Application No. 60/896,370 filed Mar. 22, 2007, which is incorporated by reference herein in its entirety.

### FIELD OF THE INVENTION

Disclosed herein are systems and methods for expanding mineral ores, including perlite, by using microwave energy.

### BACKGROUND OF THE INVENTION

Perlite products may be prepared in several ways, including milling, screening, and thermal expansion. Depending on the quality of the perlite ore and the method of processing, expanded perlite products may have various uses, including but not limited to filter aids, lightweight insulating materials (such as insulating fillers), filler materials (such as resin fillers), horticultural and hydroponic media, chemical carriers, and in the manufacture of textured coatings. Expanded perlite may also be used as an absorbent for treating oil spills. Many methods for the separation of particles from fluids employ cellular or porous siliceous media, such as diatomite or perlite, as filter aids.

Expanded perlite products have found widespread utility in filtration applications. For example, perlite products may be applied to a septum to improve clarity and increase flow rate in filtration processes in a step sometimes referred to as “precoating.” In a process known as body feeding, perlite products may also be added directly to a fluid as it is being filtered to reduce the loading of undesirable particulates at the septum while maintaining a designated liquid flow rate. Depending on the particular separation involved, perlite products may be used in precoating, body feeding, or both. Perlite products, such as surface-treated products, may enhance clarification and/or purification of a fluid.

Conventional processing of perlite may comprise comminution of the perlite ore (e.g., by crushing and/or grinding), screening, thermal expansion, milling, and/or air size separation of the expanded perlite to meet a desired specification of the final product. For example, perlite ore may undergo crushing, grinding, and separating to a predetermined particle-size range (for example, passing 30 mesh) followed by gas-flame expansion in air at a temperature ranging from 870 to 1100° C. That gas-flame expansion rapidly heats perlite ore, where the simultaneous softening of the ore and vaporization of the water contained therein leads to rapid expansion of the particles. The resulting frothy glass material may exhibit a bulk volume up to 20 times larger relative to the unexpanded perlite ore. The expanded perlite ore may then undergo further processing, for example milling and/or separating, to meet the desired specification of the final product.

Production of expanded perlite products using gas flame technology, however, may be an inefficient use of energy. For example, the efficiencies of gas flame expansion are typically no more than about 30% and may even be as low as about 20%. Consequently, operating costs due to energy consumption may adversely impact the economics of producing expanded ores, such as expanded perlite ore. Thus, a need remains to develop more energy-efficient methods of expanding perlite and other expandable ores.

Another expandable ore having numerous commercial uses is vermiculite. Typical end uses include but are not limited to insulation; soil conditioner; packing material; substrates; aggregate for plaster, concrete, mortar, and the like; firestop filler material; agricultural chemical carrier; soil additive; and hydroponic growing medium. Typically, vermiculite is expanded using a commercial furnace. But the fuel requirements, process controls, and environmental regulations necessary to operate a commercial furnace inherently add operating costs to the end product. Accordingly, there is a need for a more efficient method for expanding vermiculite.

### SUMMARY OF THE INVENTION

Further advantages of the subject matter disclosed herein will be set forth in part in the description that follows. Certain advantages of the invention may be realized and attained by the methods and systems as set forth in the Examples and appended claims. Accordingly, disclosed herein are systems and methods for expanding ores, including perlite and vermiculite ores.

One aspect disclosed herein relates to methods for expanding ores by applying microwave energy to at least one gas and passing ores through the gas. In certain embodiments, a method for expanding perlite includes applying microwave energy to at least one gas, wherein the microwave energy is applied at a frequency and power level sufficient to energize the gas, and exposing the perlite to the energized gas for a period of time sufficient to expand at least a portion of the perlite. In other embodiments, that same method may be applied to other expandable mineral ores, including, for example, hydrous silicates of metals and vermiculite.

Also disclosed herein are systems capable of expanding mineral ores consistent with the methods disclosed herein. In one embodiment, the system may comprise at least one microwave generator and at least one mineral ore feed mechanism. Optionally, the system may also comprise one or more blowers and/or compressors capable of supplying at least one of air, nitrogen, oxygen, and hydrogen.

It is to be understood that both the foregoing general description and the following detailed description are exemplary and explanatory only and are not restrictive of the invention, as claimed.

### BRIEF DESCRIPTION OF THE DRAWING

FIG. 1 depicts a scanning electron micrograph of perlite particles expanded using techniques consistent with the methods disclosed herein.

### DETAILED DESCRIPTION OF THE INVENTION AND EMBODIMENTS

One aspect disclosed herein is a method for expanding mineral ores using microwave energy. In one embodiment, microwave energy indirectly expands the ores. Instead of energizing the ore directly, microwave energy is applied to a gas, and the ore is placed into contact with the energized gas. This indirect application of microwave energy expands the ores without also melting, fusing, and/or calcining the ore into a bulky agglomeration, which may be undesirable. In another embodiment, a non-agglomerated expanded perlite product is achievable by practicing the methods disclosed herein.

In one embodiment, a method for producing an expanded mineral ore comprises applying microwave energy to at least one gas and contacting that energized gas with a mineral ore capable of expansion. Any suitable microwave energy generator may be used for the embodiments disclosed herein. Microwave energy generators are known in the art and may be designed to produce microwaves at suitable frequencies and power levels to achieve expansion of the mineral ores. For example, microwave energy generators may include gyrotrons, klystroms, traveling wave tubes, backward wave oscillators, and the like.

In one embodiment, a microwave energy generator comprises a generator, waveguides, tuning mechanisms, an applicator, and a quartz tube. The generator produces energy in the form of microwaves, which are transmitted through the waveguides into the applicator. A quartz tube may be placed in the applicator at a position suitable to form an electric field. Microwave energy reinforces the electric field within the applicator, energizing free electrons from the air, which are then used in forming an energized gas known as plasma. The mineral ore and the energized gas may contact each other in and/or adjacent to the quartz tube.

In one embodiment, the microwave energy generator produces low-frequency microwaves. Lowering the microwave frequency may provide more variability in designing the microwave energy generator equipment. For example, as the frequency decreases, the diameter of the quartz tube may be increased. Thus, utilizing low-frequency microwaves may allow for systems capable of expanding a larger amount of mineral ore relative to higher frequency microwave energy generators.

Exemplary low frequency microwaves may range from 500 MHz to 5,000 MHz. In one embodiment, the low frequency microwaves range from 800 MHz to 4,000 MHz. In another embodiment, the low frequency microwaves range from 900 MHz to 2,500 MHz. In a further embodiment, the low frequency microwaves range from 1,500 MHz to 2,000 MHz. In yet another embodiment, the low frequency microwaves range from 910 MHz to 920 MHz. In yet a further embodiment, the low frequency microwaves range from 2,445 MHz to 2,455 MHz. In still another embodiment, the low frequency microwaves are 915 MHz. In still a further embodiment, the low frequency microwaves are 2,450 MHz.

A power level for generating microwaves may be readily available at various different wattages. In one embodiment, the power level may range from 0.3 kW to 100 kW. In another embodiment, the power level ranges from 1 kW to 90 kW. In a further embodiment, the power level ranges from 20 kW to 80 kW. In yet another embodiment, the power level ranges from 40 kW to 60 kW. In yet a further embodiment, the power level ranges from 55 kW to 65 kW.

Microwave energy may be applied to any available gas or mixture of available gases. In certain embodiments, the gas may be chosen from at least one of nitrogen, oxygen, and hydrogen. In one embodiment, microwave energy is applied to air. Air is readily obtainable from the environment or may be supplied industrially. The physical properties of the gas may be standard temperature (e.g., 70° F.) and pressure (e.g., 1 atm). When air or other gases are supplied in industrial lines, the air or gas may supplied at standard temperature or pressure, or be heated and/or pressurized beyond standard temperature or pressure.

The methods disclosed herein may further comprise applying sufficient microwave energy to induce a change in state in the at least one gas into at least one plasma. As readily understood by the skilled artisan, a plasma is an ionized, energized gas with a collection of free-moving electrons and ions. When exposed to plasma, a mineral ore may experience a decrease in viscosity and spontaneously soften, and any water contained therein may boil and/or vaporize, thereby expanding the mineral ore.

Expansion indicates an increase in the volume or size of a mineral ore and may impart at least one physical characteristic to the ore, such as the presence of vesicles, a textured surface (e.g., ripples), a porous structure, and a hollow center. In one embodiment, the mineral ore is partially expanded, indicating that further expansion of the mineral ore may be possible due to, for example, potential further decreases in viscosity, the ability to further soften, or the presence of water contained within the partially expanded mineral ore that can be boiled and/or vaporized. In another embodiment, the mineral ore is fully expanded, indicating further expansion of the mineral ore may not be possible due to, for example, lack of further potential decrease in viscosity, lack of an ability to further soften, or the lack of water contained within the partially expanded mineral ore that can be boiled and/or vaporized.

Mineral ores suitable for the methods disclosed herein may include, for example, perlite, hydrous silicates of metals, vermiculite, natural glass materials, and any other mineral ore capable of expansion. In one embodiment, the mineral ore is perlite. In another embodiment, the mineral ore is vermiculite.

Mineral ore may be introduced into an energized gas or plasma by techniques known to the skilled artisan. The method by which the mineral ore is contacted with an energized gas, such as plasma, may be selected to maximize the surface area of the mineral ore exposed to the energized gas. In one embodiment, mineral ore may be gravity fed to the energized gas. For example, the outlet of a feed mechanism for the mineral may be positioned above the quartz tube or other receptacle for the energized gas, and the mineral ore may drop through the energized gas, being pulled downward by gravity. Suitable feed mechanisms may be chosen, for example, from vibratory feeders, mills, and the like.

In another embodiment, mineral ore may be introduced to the energized gas using positive air flow. A blower, air compressor, or other similar equipment can pass air through a supply of mineral ore. The mineral ore may then be entrained in the passed air and exposed to the energized gas. In yet another embodiment, mineral ore may be conveyed through the energized gas on a conveyor, such as a continuous conveyor. Regardless of the technique utilized to feed the mineral ore particles to the energized gas, the feed rate may be adjusted to minimize overfeeding or underfeeding.

The methods disclosed herein may further comprise preheating the mineral ore before it is contacted with an energized gas. Preheating the mineral ore may improve the efficiency in which the mineral ore is expanded. In certain embodiments, mineral ore may be preheated to a temperature ranging from 25° C. to 800° C. In certain embodiments, the higher the preheating temperature, the less exposure the mineral ore may need to the energized gas. In one embodiment, the mineral ore is perlite, the perlite is heated up to 600° C. and is then subjected to an energized gas, such as a plasma.

The methods disclosed herein may further comprise classifying the expanded or unexpanded mineral ores to a desired particle size. The classification equipment may be chosen from at least one of air classifiers, cyclone funnels, sieve screens, and other equipment capable of classifying particles. The expanded mineral ores may be classified into varying degrees of fine and coarse fractions suitable for the desired end uses, such as filtration or paint additives. Classification may also be used to separate expanded mineral ores from unexpanded mineral ores after exposure to the at least one energized gas. The unexpanded mineral ores may then be recycled and re-exposed to the energized gas.

In another embodiment, the methods disclosed herein further comprise first classifying the unexpanded mineral ore before contacting it with an energized gas. The classification equipment or mechanism may be chosen from at least one of air classifiers, cyclone funnels, sieve screens, and other equipment capable of classifying particles.

Another embodiment disclosed herein is a microwave system configured to expand mineral ores. The system may comprise an apparatus designed to produce microwaves in the frequencies utilized in the methods disclosed herein. As disclosed herein, one such system may comprise a generator, waveguides, tuning mechanisms, applicator, and a quartz tube.

In one embodiment, the system may further comprise a feed mechanism capable of dispensing mineral ore. Suitable feed mechanisms may be chosen, for example, from vibratory feeders, mills, conveyors, and the like. In another embodiment, the system may further comprise a blower and/or compressor for supplying air or other gases. In a further embodiment, the system may further comprise classification equipment for separating the mineral ores.

Unless otherwise indicated, all numbers expressing quantities of ingredients, reaction conditions, and so forth used in the specification, including claims, are to be understood as being modified in all instances by the term “about.” Accordingly, unless otherwise indicated to the contrary, the numerical parameters are approximations and may vary depending upon the desired properties sought to be obtained by the present invention. At the very least, and not as an attempt to limit the application of the doctrine of equivalents to the scope of the claims, each numerical parameter should be construed in light of the number of significant digits and ordinary rounding approaches. Unless otherwise indicated, the term “at least” preceding a series of elements is to be understood to refer to every element in the series.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

### EXAMPLES

### Materials and Apparatus

A 6 kW microwave generator having a frequency of 2450 MHz was used to generate a gas plasma. The generator produced microwave energy, and the energy was transmitted through aluminum waveguides into a single mode, water-cooled applicator. An air-cooled quartz tube was placed in the applicator at a position where the microwaves formed a maximum electrical field. Microwave energy continuously reinforced the electric field within the applicator, energizing free electrons from the air used to form a plasma.

The single mode, water-cooled applicator focused the microwave energy to form a high electrical field. The applicator comprised a movable back wall, or a sliding short circuit, to facilitate placing the peak energy field where the plasma formed. Reflected microwaves were minimized by tuning. Tuning involved moving the sliding short circuit until a minimum power was achieved.

The feed was HARBORLITE perlite ore produced from Superior, Ariz. (World Minerals, Inc.; Lompoc, Calif., U.S.A.). The perlite ore was sized using mesh screens ranging from 50 mesh to 100 mesh in size (US Mesh Sizes), yielding ores ranging in size from about 300 microns to about 600 microns in diameter. Perlite was delivered to the plasma using a vibratory feeder. The density of the unexpanded perlite ranged from 60 to 70 lb/ft³.

### Example 1

The quartz tube top extended 1 inch above the top surface of the applicator and 1-2 inches below the bottom of the applicator. In this configuration, the plasma extended out of the quartz tube opening above the applicator. The vibratory feeder tip was placed directly above the center of the quartz tube within 1 inch of the tube top. The perlite was fed from the vibratory feeder directly into the quartz tube containing the plasma.

As perlite contacted the plasma, a portion of the perlite expanded and was carried into the air above the applicator, part of it coming to rest on the surface of the applicator and the remainder was carried into the environment. Another portion of the perlite passed through the quartz tube and dropped in a glass beaker placed beneath the applicator. Expanded perlite material was collected from both the top surface of the applicator and the beaker.

### Example 2

A sub-assembly was positioned below the quartz tube. This sub-assembly was configured to feed perlite to the quartz tube using positive air flow. The perlite feed line was insert at a 45° angle downward to intersect the positive air flow in the sub-assembly and force the perlite into the plasma, exiting the tip of the quartz tube.

A larger U-shaped tube was placed over the quartz tube at the top of the applicator, while the other end of the U-tube fed into the glass beaker. A hole was cut in synthetic filter cloth to pass the U-tube into the beaker, while the filter cloth was placed over the top of the beaker to hold the perlite inside and allowing the positive air flow to pass through the cloth. The U-tube was placed over the quartz tube after the plasma was struck.

The positive air flow passed the majority of the perlite through the plasma, and the perlite did not expand. The particular air flow initiated instability in the plasma, rendering it unstable and extinguished after a few seconds. Expanded perlite was not collected.

### Example 3

The length of the quartz tube above the applicator was increased to provide greater contact space between the perlite and plasma. The copper cylinder was removed from the bottom of the quartz tube, so that perlite could pass through the tube into a beaker below. The feed rate was reduced to determine the effect on the ratio of expanded to unexpanded perlite.

The perlite passed from the feeder into the plasma in and above the quartz tube where the perlite expanded. The expanded and any unexpanded perlite was carried into the air above the applicator and came to rest on the applicator's top surface or was carried away in the atmosphere. Virtually no perlite entered the beaker below the quartz tube. Cyclonic air flow was observed, and some of the perlite flowed in a swirling motion as it fell into and passed out of the plasma.

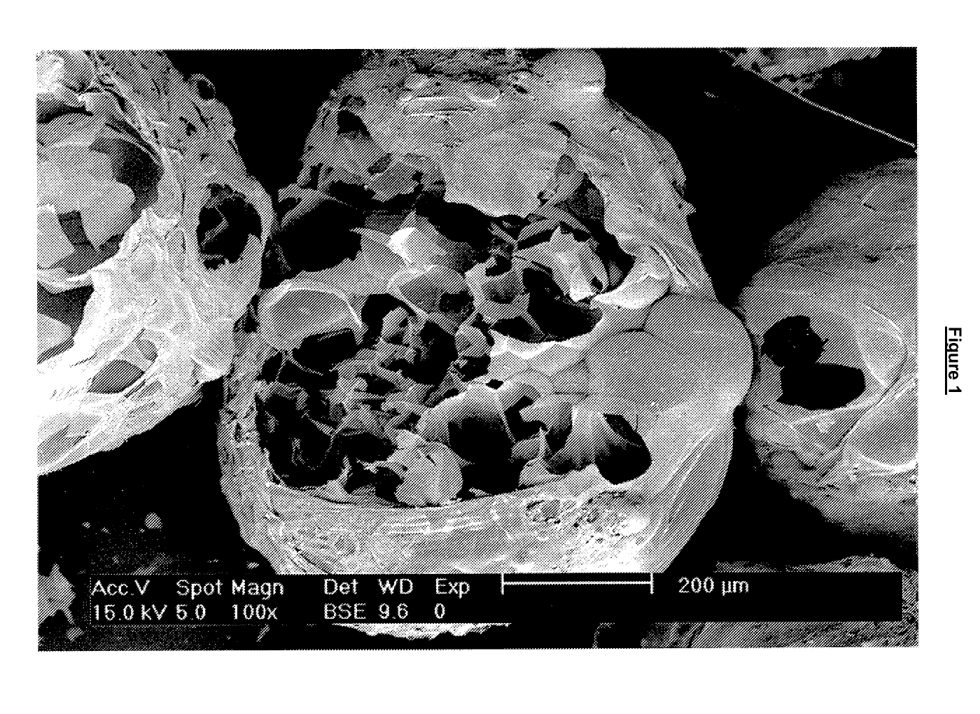

A sample of expanded perlite was measured for loose weight and examined by scanning electron microscope. The loose weight density was measured as 4.1 lb/ft³ (65.7 g/L). FIG. 1 depicts a micrograph of the perlite particle sample, which shows large expanded vesicles, rippled glass surfaces, delicate pore structure, and expansion within particle centers.

1. A method for producing expanded mineral ore particles comprising:
applying microwave energy to at least one gas to form at least one energized gas; and
exposing particles of at least one mineral ore to the at least one energized gas for a period of time sufficient to at least partially expand at least a portion of the particles.

2. The method according to claim 1, further comprising heating the particles to a temperature no greater than about 600° C. before exposing the particles to the at least one energized gas.

3. (canceled)

4. The method according to claim 1, further comprising classifying the expanded particles.

5. The method according to claim 1, wherein the at least one energized gas is a plasma.

6. The method according to claim 1, wherein the microwave energy is applied at a frequency ranging from about 500 MHz to about 5,000 MHz.

7. The method according to claim 6, wherein the microwave energy is applied at a frequency ranging from about 900 MHz to about 2,500 MHz.

8. The method according to claim 7, wherein the microwave energy is applied at a frequency of about 2,450 MHz.

9. The method according to claim 1, wherein the at least one mineral ore is perlite.

10. The method according to claim 1, wherein the at least one mineral ore is vermiculite.

11. The method according to claim 1, wherein the at least one gas is chosen from the group consisting of air, hydrogen, nitrogen, and oxygen.

12. The method according to claim 11, wherein the at least one gas is air.

13. The method according to claim 1, wherein the microwave energy is generated at a power level ranging from about 0.3 kW to about 100 kW.

14. The method according to claim 1, wherein the particles pass through the energized gas through the use of gravity.

15. The method according to claim 1, wherein the particles pass through the energized gas through the use of positive air flow.

16. The method according to claim 1, wherein the particles pass through the energized gas through the use of a conveyor.

17. A method for expanding mineral ore particles comprising indirectly heating particles of at least one mineral ore with microwaves having a frequency of less than about 5000 MHz, whereby the particles are at least partially expanded.

18. The method according to claim 17, wherein the at least one mineral ore is perlite.

19. The method according to claim 17, wherein the frequency is less than about 2,500 MHz.

20. The method according to claim 19, wherein the frequency is about 920 MHz or less.

21. The method according to claim 17, wherein the at least one mineral ore is vermiculite.

22. A system for expanding particles of at least one mineral ore comprising:
a microwave generator capable of generating microwaves having a frequency of about 5000 MHz or less;
a supply of at least one gas; and,
a feed mechanism capable of dispersing particles of at least one mineral ore to the gas.

23-28. (canceled)
